(19) United States
(12) Patent Application Publication
(10) Pub. No.: US 2024/0088492 A1
(43) Pub. Date: Mar. 14, 2024

(54) Cylindrical Battery and Cylindrical Battery Module

(71) Applicant: JIANGSU ZENERGY BATTERY TECHNOLOGIES CO., LTD., Jiangsi (CN)

(72) Inventor: Hongjiang YU, Jiangsu (CN)

(21) Appl. No.: 18/243,658

(22) Filed: Sep. 7, 2023

(30) Foreign Application Priority Data
Sep. 8, 2022 (CN) 202222388464.7

(51) Int. Cl. H01M 50/179; H01M 50/107; H01M 50/152; H01M 50/184; H01M 50/186; H01M 50/213

(52) U.S. Cl. CPC H01M 50/179; H01M 50/107; H01M 50/152; H01M 50/184; H01M 50/186; H01M 50/213

(57) ABSTRACT

Disclosed are a cylindrical battery and a cylindrical battery module. The cylindrical battery includes: a housing provided with a first main body portion and an opening portion, the diameter of the opening portion is greater than that of the first main body portion; a top cover covering the opening portion and being connected to the opening portion in an insulating manner; a cell arranged in the first main body portion, both ends of the cell are respectively provided with a first tab and a second tab with opposite polarities, the first tab is connected to the top cover; a conductive portion penetrating through the cell, one end of the conductive portion is connected to the second tab, the other end of the conductive portion penetrates out from the top cover and is connected to the top cover in an insulating manner.

### CROSS-REFERENCE TO RELATED APPLICATION

The disclosure claims priority to and the benefit of Chinese Patent Application No. 202222388464.7, filed to the China National Intellectual Property Administration (CH IPA) on 8 Sep. 2022, which is hereby incorporated by reference in its entirety.

### TECHNICAL FIELD

The disclosure relates to the technical field of cylindrical battery production and manufacturing, and in particularly to a cylindrical battery and a cylindrical battery module.

### BACKGROUND

With the development of science and technology, secondary cylindrical batteries have been widely used in portable electronic devices such as mobile phones, digital cameras, and laptops, and have broad application prospects in electric vehicles such as electric cars and electric bicycles, and large and medium-sized electric devices such as energy storage facilities, thereby becoming an important technical means to solve global problems such as energy crisis and environmental pollution. As a new secondary cylindrical battery, a lithium-ion cylindrical battery has the advantages of high energy density and power density, high working voltage, light weight, small size, long cycle life, good safety, green and environmental protection, etc., and has broad application prospects in portable electrical appliances, electric tools, large energy storage, electric traffic power sources, etc.

In the related art, a positive tab and a negative tab are arranged at both ends of a cylindrical cell, and a positive electrode post and a negative electrode post are lead out from both ends of the cylindrical battery, and then are connected in series and in parallel to form a cylindrical battery module. However, a positive electrode and a negative electrode of the cylindrical battery with the structure are respectively led out from both ends, which is not conducive to the design and welding of a busbar of the cylindrical battery module in the later period, and affects the subsequent assembly of the cylindrical battery module.

### SUMMARY

The disclosure aims to provide a cylindrical battery for the defects in the related art, so as to solve the problem that a positive electrode and a negative electrode of the cylindrical battery are respectively led out from both ends, which is not conducive to the design and welding of a busbar of the cylindrical battery module in the later period.

In order to achieve the above objective, the disclosure adopts the following technical solutions.

Some embodiments of the disclosure provide a cylindrical battery, including:

a housing, the housing is provided with a first main body portion and an opening portion, and the diameter of the opening portion is greater than the diameter of the first main body portion;

a top cover, the top cover covers the opening portion and is connected to the opening portion in an insulating manner;

a cell, the cell is arranged in the first main body portion, both ends of the cell are respectively provided with a first tab and a second tab, the polarity of the first tab is opposite to the polarity of the second tab, and the first tab is connected to the top cover; and

a conductive portion, the conductive portion penetrates through the cell, one end of the conductive portion is connected to the second tab, and the other end of the conductive portion penetrates out from the top cover and is connected to the top cover in an insulating manner.

In some embodiments, a weak portion is arranged on the top cover, and the first tab is connected to the weak portion.

In some embodiments, the shape of the orthographic projection of the weak portion on the top cover is one of an arc, a circle, an ellipse, or a rectangle.

In some embodiments, the cell is axially provided with a channel, and the conductive portion penetrates through the cell by the channel.

In some embodiments, the top cover is provided with a first through hole, and the other end of the conductive portion penetrates out from the top cover by the first through hole.

In some embodiments, the conductive portion includes a second main body portion, a first end portion, and a second end portion. The second main body portion penetrates through the channel, the first end portion is arranged at the bottom of the housing, and is connected to one end of the second main body portion and the second tab, the second end portion is arranged on the first through hole and is connected to the first through hole in an insulating manner, and the second end portion is connected with the other end of the second main body portion.

In some embodiments, both of the cross-sectional shape of the second end portion and the cross-sectional shape of the second main body portion are T-shaped or I-shaped.

In some embodiments, an insulating seal is arranged between the second end portion and the first through hole.

In some embodiments, the insulating seal includes a first protrusion and a second protrusion. The first protrusion and the second protrusion are oppositely arranged on both sides of the top cover; and the first protrusion and the second protrusion are partially accommodated in the first through hole; or the first protrusion or the second protrusion is partially accommodated in the first through hole.

Some other embodiments of the disclosure further aims to provide a cylindrical battery module, including a box body and a plurality of batteries. The plurality of batteries are arranged in the box body in sequence along a thickness direction of the box body, and at least one of the plurality of batteries is the cylindrical battery as previously described.

The disclosure has the beneficial effects that: for the cylindrical battery, by an arrangement of the conductive portion, the conductive portion opens up a new current path, the conductive portion penetrates through the cell, after one end of the conductive portion is connected to the second tab, the polarity of the second tab is led out from the top cover, so that a cylindrical battery with a positive electrode and a negative electrode at one end is formed, which facilitates the design and welding of the busbar of the cylindrical battery module in the later period and improves the assembly efficiency of the cylindrical battery module.

### BRIEF DESCRIPTION OF THE DRAWINGS

The features, advantages, and technical effects of embodiments of the disclosure will be described below with reference to the accompanying drawings.

FIG. 1 is a schematic structural diagram of the disclosure.

FIG. 2 is another schematic structural diagram of the disclosure.

FIG. 3 is an enlarged schematic structural diagram at a position A in FIG. 2.

FIG. 4 is a schematic structural diagram of a housing of the disclosure.

Reference signs are as follows:
100, cylindrical battery;
10, housing; 11, first main body portion; 12, opening portion;
20, top cover; 21, first through hole; 22, weak portion;
30, cell; 31, first tab; 32, second tab; 33, channel;
40, conductive portion; 41, second main body portion; 42, first end portion; 43, second end portion; and
50, insulating seal; 51, first protrusion; 52, second protrusion.

### DETAILED DESCRIPTION OF THE EMBODIMENTS

Certain terms are used, for example, in the description and claims to refer to particular components. Those skilled in the art should understand that a hardware manufacturer may use different terms to refer to the same component. The specification and claims do not use the difference in name as a way to distinguish components, but use the difference in function of components as a criterion for distinguishing. As mentioned throughout the specification and claims, “comprising” is an open term, so it should be interpreted as “including but not limited to”. “Approximately” means that within an acceptable error range, those skilled in the art can solve technical problems within a certain error range and basically achieve technical effects.

In addition, terms “first” and “second” are only used for describing purposes, and cannot be understood as indicating or implying relative importance.

In the disclosure, unless otherwise clearly specified and limited, the terms “installation”, “connection”, “fixation” and other terms shall be understood in a broad sense. For example, the term may be a fixed connection or a detachable connection, or an integrated connection; the term may be a mechanical connection or an electric connection; and the term may be a direct connection or an indirect connection through an intermediary, and may be communication inside two components. Those of ordinary skill in the art may understand the specific meanings of the terms in the disclosure according to specific conditions.

“Embodiment” mentioned herein means that a specific feature, structure, or characteristic described in combination with an embodiment may be included in at least one embodiment of the disclosure. The phrase appearing anywhere in the specification does not always refer to the same embodiment or an independent or alternative embodiment mutually exclusive of another embodiment.

As used herein, term “and/or” is only an association relationship describing associated objects, and represents that three relationships may exist. For example, A and/or B may represent three conditions: i.e., existence of only A, existence of both A and B, and existence of only B. In addition, character “/” herein usually represents that previous and next associated objects form an “or” relationship.

The term “a plurality of” used herein refers to more than two (including two).

Some embodiments of the disclosure provide a cylindrical battery module, including a box body and a plurality of batteries. The plurality of batteries are arranged in the box body in sequence along a thickness direction of the box body.

In some embodiments, there are one or more batteries. If there are the plurality of batteries, series or parallel or series-parallel connection of the plurality of batteries is realized. The series-parallel connection means that the plurality of batteries are both connected in series and in parallel. The plurality of batteries are directly connected in series or parallel or series-parallel together, and then a whole composed of the plurality of batteries is accommodated in the box body. Of course, the plurality of batteries are connected in series or parallel or series-parallel first to form a cylindrical battery module, and a plurality of cylindrical battery modules are connected in series or parallel or series-parallel to form a whole to be accommodated in the box body.

The plurality of batteries in the cylindrical battery module are electrically connected by busbar components to realize the parallel or series or series-parallel connection of the plurality of batteries in the cylindrical battery module.

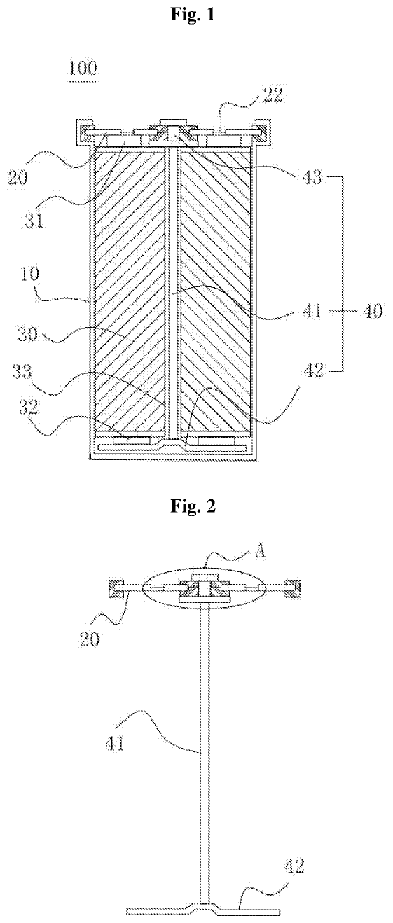

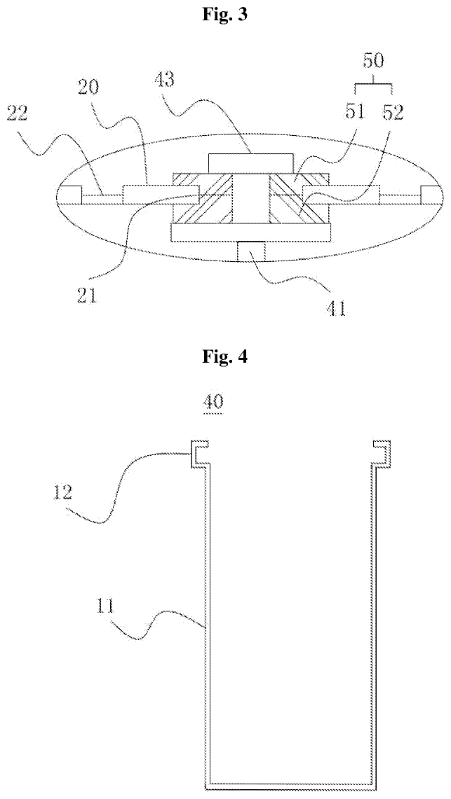

Referring to FIGS. 1-4, some embodiments of the disclosure provide a cylindrical battery 100. The cylindrical battery 100 is a battery cell and is suitable for a cylindrical battery module.

In some embodiments of the disclosure, the cylindrical battery 100 includes a housing 10, a top cover 20, a cell 30 and a conductive portion 40. The housing 10 is provided with a first main body portion 11 and an opening portion 12, and the diameter of the opening portion 12 is greater than the diameter of the first main body portion 11. The top cover 20 covers the opening portion 12 and is connected to the opening portion 12 in an insulating manner. The cell 30 is arranged in the first main body portion 11.

In the embodiments of the disclosure, both ends of the cell 30 are respectively provided with a first tab 31 and a second tab 32, the polarity of the first tab 31 is opposite to the polarity of the second tab 32, and the first tab 31 is connected to the top cover 20, and the connection is welding, including ultrasonic welding, laser welding or resistance welding. The polarity of the top cover 20 is the same as the polarity of the first tab 31.

Specifically, the cell 30 includes a positive electrode plate, a negative electrode plate and a separator. The battery cell runs mainly relying on the movement of metal ions between the positive electrode plate and the negative electrode plate. The positive electrode plate includes a positive current collector and a positive active material layer. The positive active material layer is coated on a surface of the positive current collector. The positive current collector includes a positive coating area and a positive tab connected to the positive coating area, the positive coating area is coated with the positive active material layer, and the positive tab is not coated with the positive active material layer. Taking a lithium-ion cylindrical battery 100 as an example, the material of the positive current collector is aluminum. The positive active material layer includes a positive active material, and the positive active material is lithium cobaltate, lithium iron phosphate, ternary lithium or lithium manganate, etc. The negative electrode plate includes a negative current collector and a negative active material layer. The negative active material layer is coated on a surface of the negative current collector. The negative current collector includes a negative coating area and a negative tab connected to the negative coating area, the negative coating area is coated with the negative active material layer, and the negative tab is not coated with the negative active material layer. The material of the negative current collector is copper, the negative active material layer includes a negative active material, and the negative active material is carbon, or silicon, etc. The material of the separator is polypropylene (PP) or polyethylene (PE).

It is to be noted that when the first tab 31 is a positive tab, the second tab 32 is a negative tab; when the second tab 32 is the positive tab, the first tab 31 is the negative tab.

In the embodiments of the disclosure, the conductive portion 40 penetrates through the cell 30, one end of the conductive portion 40 is connected to the second tab 32, and the other end of the conductive portion 40 penetrates out from the top cover 20 and is connected to the top cover 20 in an insulating manner. The connection is welding, including ultrasonic welding, laser welding or resistance welding. One end of the conductive portion 40 is connected to the second tab 32, and the other end of the conductive portion 40 penetrates out from the top cover 20, so that the polarity of the end is led out to the other end, and therefore the cylindrical battery 100 leading out the positive electrode and the negative electrode at the same end is realized, which facilitates the design and welding of a busbar of the cylindrical battery module in the later period, and improves the assembly efficiency of the cylindrical battery module.

In some embodiments, the shape of the housing 10 is a cylinder, and when the shape of the cell 30 corresponds to the cylinder, the shapes of the two are adaptively assembled. When the shape of the cell 30 is a polygon, the shape of the housing 10 is still the cylinder, at this time, the cell 30 produces gas and expands after charging and discharging, and there is still a reserved space between the cell 30 and the housing 10, on the one hand, expansion of the cell 30 is allowed, on the other hand, the periphery of the cell 30 is prevented from being squeezed by the housing 10.

Further, an insulating layer is arranged at the bottom of the housing 10 to prevent a contact between one end of the conductive portion 40 and the bottom of the housing 10 from causing corrosion of the housing 10.

In the embodiments of the disclosure, the top cover 20 and the housing 10 are connected by pier sealing, so that the top cover 20 is insulated from the housing 10 to prevent a contact between the top cover 20 and the housing 10 with different polarities from causing a short circuit of the cylindrical battery 100. At the same time, the diameter of the opening portion 12 of the housing 10 is greater than the diameter of the first main body portion 11. During the pier sealing, the opening portion 12 supports the top cover 20, which effectively ensures the pier sealing of the top cover 20 and the housing 10, and prevents the deformation of the cell 30 when the cell 30 is squeezed by the top cover 20.

Compared with the related dart, some embodiments of the disclosure provide the cylindrical battery, by an arrangement of the conductive portion 40, the conductive portion 40 opens up a new current path, the conductive portion 40 penetrates through the cell 30, after one end of the conductive portion is connected to the second tab 32, the polarity of the second tab 32 is led out from the top cover 20, so that the cylindrical battery 100 with a positive electrode and a negative electrode at one end is formed, which facilitates the design and welding of the busbar of the cylindrical battery module in the later period and improves the assembly efficiency of the cylindrical battery module.

It is to be noted that the first tab 31 is connected to the top cover 20, the connection between the first tab 31 and the top cover 20 by a current collector plate is cancelled, which reduces the welding position or welding times, and then reduces the impact of welding slag on product performance.

In some embodiments of the disclosure, a weak portion 22 is arranged on the top cover 20, and the first tab 31 is connected to the weak portion 22. The thickness of the weak portion 22 is less than the thicknesses of other portions of the top cover 20. Compared with other portions of the top cover 20, the first tab 31 is welded with the weak portion 22 to improve the welding efficiency.

Further, the shape of the orthographic projection of the weak portion 22 on the top cover 20 is one of an arc, a circle, an ellipse, or a rectangle.

Specifically, there are one or more weak portions 22. The weak portion 22 is arranged at any position on the top cover 20. For example, the weak portion 22 is arranged on the periphery of the top cover 20, or a center axis of the weak portion 22 is coaxial with a center axis of the top cover 20.

In some embodiments of the disclosure, the cell 30 is axially provided with a channel 33, and the conductive portion 40 penetrates through the cell 30 by the channel 33. The conductive portion 40 penetrates through the channel 33 of the cell 30, which effectively assists the conductive portion 40 in leading the polarity of the second tab 32 out from the top cover 20.

In some embodiments of the disclosure, the top cover 20 is provided with a first through hole 21, and the other end of the conductive portion 40 penetrates out from the top cover 20 by the first through hole 21. By an arrangement of the first through hole 21, the other end of the conductive portion 40 penetrates out from the inside of the cylindrical battery 100 by the first through hole 21, and the other end of the conductive portion 40 is configured for external connection.

Referring to FIGS. 1-3, in some embodiments of the disclosure, the conductive portion 40 includes a second main body portion 41, a first end portion 42 and a second end portion 43. The second main body portion 41 penetrates through the channel 33, the first end portion 42 is arranged at the bottom of the housing 10, and is connected to one end of the second main body portion 41 and the second tab 32, the second end portion 43 is arranged on the first through hole 21 and is connected to the first through hole 21 in an insulating manner, and the second end portion 43 is connected to the other end of the second main body portion 41. The first end portion 42 is connected to one end of the second main body portion 41 and the second tab 32, and the other end of the second main body portion 41 is connected to the second end portion 43, so that a structure of the conductive portion 40 is effectively arranged to lead the polarity of the second tab 32 out from the top cover 20, and therefore the polarity of the second tab 32 and the polarity of the first tab 31 are located at one end of the cylindrical battery 100. The second end portion 43 is insulated with the first through hole 21, which effectively prevents a contact between the second end portion 43 and the top cover 20 from causing a short circuit of the cylindrical battery 100.

Specifically, the conductive portion 40 is an integrally formed structure or a split structure. When the conductive portion 40 is the integrally formed structure, the second main body portion 41, the first end portion 42, and the second end portion 43 form an integrally formed member. When the conductive portion 40 is the split structure, the second main body portion 41 and the first end portion 42 form an integrally formed member, and the second end portion 43 is a separate member, the two members are in welded, screwed or riveted connection, that is, the other end of the second main body portion 41 and the second end portion 43 are in welded, screwed or riveted connection.

Specifically, the material of the conductive portion 40 is aluminum, copper, nickel or aluminum-nickel alloy. The conductive portion 40 is a single layer structure or a multi-layer structure. When the conductive portion 40 is the multi-layer structure, an outer structure of the conductive portion 40 is an insulating layer or a thermal conductive layer. The insulating layer is a polymer layer that absorbs an electrolyte. When the electrolyte in the cylindrical battery 100 is reduced after charging and discharging for many times, a part of the electrolyte is released to improve a cycle performance of the cylindrical battery 100.

Further, the second main body portion 41 is a solid structure or a hollow structure. When the second main body portion 41 is the hollow structure, a storage of the electrolyte is facilitated, at the same time, a side wall of the second main body portion 41 is provided with a second through hole or a sponge porous structure, which is convenient for the electrolyte to pass through the second through hole or a hole of the sponge porous structure, and is conducive to an infiltration of the electrolyte and reducing a weight of the cylindrical battery 100.

Further, both of the cross-sectional shape of the second end portion 43 and the cross-sectional shape of the second main body portion 41 are T-shaped or I-shaped. The cross-sectional shape of the second end portion 43 and the cross-sectional shape of the second main body portion 41 are arranged according to the actual needs.

It is to be noted that the conductive portion 40 penetrates through the channel 33 of the cell 30, the second main body portion 41 is located in the channel 33 of the cell 30, the first end portion 42 is located at one end of the cell 30, the first end portion 42 is cut and bent, and the first end portion 42 is connected to the second tab 32 by welding.

An insulating seal 50 is arranged between the second end portion 43 and the first through hole 21. The insulating seal 50 is configured to effectively prevent a contact between the second end portion 43 and the top cover 20 from causing the short circuit of the cylindrical battery 100.

The insulating seal 50 includes a first protrusion 51 and a second protrusion 52. The first protrusion 51 and the second protrusion 52 are oppositely arranged on both sides of the top cover 20; a part of the first protrusion 51 and a part of the second protrusion 52 are accommodated in the first through hole 21; or a part of the first protrusion 51 or a part of the second protrusion 52 is partially accommodated in the first through hole 21. The first protrusion 51 and the second protrusion 52 are configured to prevent a contact between the second end portion 43 and the top cover 20, by accommodating the first protrusion 51 and/or the second protrusion 52 in the first through hole 21 partially, a gap between the second end portion 43 and the first through hole 21 is filled, the second end portion 43 is fixed, while a contact between the second end portion 43 and the side wall of the first through hole 21 is prevented.

It is to be noted that the second end portion 43 and the insulating seal 50 are located at the first through hole 21 of the top cover 20, and the insulating seal 50 is located between the second end portion 43 and the first through hole 21. By heating and stamping, the second end portion 43, the insulating seal 50 and the top cover 20 are combined. The gap between the second end portion 43 and the first through hole 21 is filled by the insulating seal 50.

Further, the cross-sectional shape of the first protrusion 51 and the cross-sectional shape of the second protrusion 52 are line-shaped or T-shaped; or the cross-sectional shape of the first protrusion 51 or the cross-sectional shape of the second protrusion 52 is line-shaped or T-shaped.

According to the disclosure and teaching of the above specification, those skilled in the art to which the disclosure pertains can also change and modify the above embodiments. Therefore, the disclosure is not limited to the above specific embodiments, and any obvious improvement, substitution or modification made by those skilled in the art on the basis of the disclosure shall fall within the scope of protection of the disclosure. In addition, although some specific terms are used in the specification, these terms are only for convenience of description and do not constitute any limitation to the disclosure.

What is claimed is:

1. A cylindrical battery, comprising:
a housing;
a top cover, the top cover is connected to an opening portion in an insulating manner;
a cell, the cell is arranged in the housing, both ends of the cell are respectively provided with a first tab and a second tab, the polarity of the first tab is opposite to the polarity of the second tab, and the first tab is connected to the top cover; and
a conductive portion, the conductive portion penetrates through the cell, one end of the conductive portion is connected to the second tab, and the other end of the conductive portion penetrates out from the top cover and is connected to the top cover in an insulating manner.

2. The cylindrical battery according to claim 1, wherein the housing is provided with a first main body portion and the opening portion, the diameter of the opening portion is greater than the diameter of the first main body portion, and the top cover covers the opening portion.

3. The cylindrical battery according to claim 1, wherein a weak portion is arranged on the top cover, and the first tab is connected to the weak portion.

4. The cylindrical battery according to claim 3, wherein the shape of the orthographic projection of the weak portion on the top cover is one of an arc, a circle, an ellipse, or a rectangle.

5. The cylindrical battery according to claim 1, wherein the cell is axially provided with a channel, and the conductive portion penetrates through the cell by the channel.

6. The cylindrical battery according to claim 5, wherein the top cover is provided with a first through hole, and the other end of the conductive portion penetrates out from the top cover by the first through hole.

7. The cylindrical battery according to claim 6, wherein the conductive portion comprises a second main body portion, a first end portion, and a second end portion, and the second main body portion penetrates through the channel, the first end portion is arranged at the bottom of the housing, and is connected to one end of the second main body portion and the second tab, the second end portion is arranged on the first through hole and is connected to the first through hole in an insulating manner, and the second end portion is connected to the other end of the second main body portion.

8. The cylindrical battery according to claim 7, wherein a side wall of the second main body portion is provided with a second through hole or a sponge porous structure.

9. The cylindrical battery according to claim 7, wherein both of the cross-sectional shape of the second end portion and the cross-sectional shape of the second main body portion are T-shaped or I-shaped.

10. The cylindrical battery according to claim 7, wherein an insulating seal is arranged between the second end portion and the first through hole.

11. The cylindrical battery according to claim 10, wherein the insulating seal comprises a first protrusion and a second protrusion, and the first protrusion and the second protrusion are oppositely arranged on both sides of the top cover;
a part of the first protrusion and a part of the second protrusion are accommodated in the first through hole; or a part of the first protrusion or a part of the second protrusion is partially accommodated in the first through hole.

12. The cylindrical battery according to claim 1, wherein the shape of a cell is a cylinder or a polygon, and the shape of the housing is the cylinder.

13. The cylindrical battery according to claim 1, wherein an insulating layer is arranged at the bottom of the housing.

14. The cylindrical battery according to claim 1, wherein the conductive portion is a single layer structure or a multi-layer structure.

15. The cylindrical battery according to claim 14, wherein when the conductive portion is the multi-layer structure, an outer structure of the conductive portion is an insulating layer or a thermal conductive layer.

16. A cylindrical battery module, comprising a box body and a plurality of batteries, and the plurality of batteries are arranged in the box body in sequence along a thickness direction of the box body, and at least one of the plurality of batteries is the cylindrical battery according to claim 1.

17. The cylindrical battery module according to claim 16, wherein a weak portion is arranged on the top cover, and the first tab is connected to the weak portion, and the shape of the orthographic projection of the weak portion on the top cover is one of an arc, a circle, an ellipse, or a rectangle.

18. The cylindrical battery module according to claim 16, wherein the cell is axially provided with a channel, and the conductive portion penetrates through the cell by the channel, the top cover is provided with a first through hole, and the other end of the conductive portion penetrates out from the top cover by the first through hole, and the conductive portion comprises a second main body portion, a first end portion, and a second end portion, and the second main body portion penetrates through the channel, the first end portion is arranged at the bottom of the housing, and is connected to one end of the second main body portion and the second tab, the second end portion is arranged on the first through hole and is connected to the first through hole in an insulating manner, and the second end portion is connected to the other end of the second main body portion.

19. The cylindrical battery module according to claim 18, wherein both of the cross-sectional shape of the second end portion and the cross-sectional shape of the second main body portion are T-shaped or I-shaped.

20. The cylindrical battery module according to claim 18, wherein an insulating seal is arranged between the second end portion and the first through hole, the insulating seal comprises a first protrusion and a second protrusion, and the first protrusion and the second protrusion are oppositely arranged on both sides of the top cover;
the first protrusion and the second protrusion are partially accommodated in the first through hole; or the first protrusion or the second protrusion is partially accommodated in the first through hole.
